(19) United States
(12) Patent Application Publication
(10) Pub. No.: US 2025/0283447 A1
(43) Pub. Date: Sep. 11, 2025

(54) TIDAL POWER GENERATION SYSTEM.

(71) Applicants: Nick Huard, Kahnawake (CA); Serge Laberge, Québec (CA); Daniel Lachance, Québec (CA)

(72) Inventors: Nick Huard, Kahnawake (CA); Serge Laberge, Québec (CA); Daniel Lachance, Québec (CA)

(21) Appl. No.: 19/069,996

(22) Filed: Mar. 4, 2025

(30) Foreign Application Priority Data
Mar. 5, 2024 (GB) 2403219.5

(51) Int. Cl. F03B 13/26; B63B 35/44

(52) U.S. Cl. CPC F03B 13/26; B63B 35/44; B63B 2035/4466; F05B 2220/706

(57) ABSTRACT

A tidal energy capture system for powering a power generator by capturing tidal energy in a body of water experiencing tides, comprising: a base mounted to a ground; a float floating in the body of water adjacent the base; and an arm extending between the base and the float and pivotable relative to the base, the arm being connectable to the power generator for powering the power generator when the float is moved up and down relative to the base by the tides.

### FIELD OF THE INVENTION

The present invention relates to the general field of power generation, and, more particularly, to a tidal power generation system.

### BACKGROUND

Over the last century, a relatively large number of sea shore based and off shore based configurations of tidal power generation systems have been proposed to harness the renewable energy represented by the movements of the sea due to the tides. While these known tidal power generation systems of the prior art can generally fulfill the main objective of providing a means to convert this vertical movement of the sea tide into electrical or mechanical power, they also generally include one or more of the following disadvantages. For example, sea shore based tidal power generation generally require to be built in immediate proximity to the sea shore, if not partially into the waters near the sea shore. This location requirement often implies extended construction engineering expenses when the sea shore is represented by unstable grounds or is blocked by large and uneven rock formations.

Furthermore, the relatively complex functional configurations of sea shore based, as well as offshore based, tidal power generation systems of the prior art are generally not particularly well suited to sustain repetitive structural stress caused by the more and more frequent occurrence of category 4 or 5 sea hurricanes due to climate change.

Thus, there is a need for improved tidal power generation systems. An object of the present invention is to provide such improved systems.

### SUMMARY OF THE INVENTION

In a broad aspect, there is provided a tidal energy capture system for powering a power generator by capturing tidal energy in a body of water experiencing tides, comprising: a base mounted to a ground; a float floating in the body of water adjacent the base; and an arm extending between the base and the float and pivotable relative to the base, the arm being connectable to the power generator for powering the power generator when the float is moved up and down relative to the base by tides.

There may also be provided a tidal energy capture system wherein the ground is above sea level coastal ground.

There may also be provided a tidal energy capture system wherein the ground is submerged ground located under the body of water.

There may also be provided a tidal energy capture system wherein the base is supported on the ground.

There may also be provided a tidal energy capture system wherein the base is buoyant and anchored to the ground.

There may also be provided a tidal energy capture system wherein the arm is telescopic.

There may also be provided a tidal energy capture system wherein the float is provided with a ballast system for selectively adjusting a buoyancy of the float.

There may also be provided a tidal energy capture system wherein the float is selectively submersible.

There may also be provided a tidal energy capture system wherein the ballast system includes a snorkel for accessing the atmosphere to pump air in the ballast system when emptying the ballast system.

There may also be provided a tidal energy capture system further comprising a hydraulic cylinder extending between the base and the arm and operative for selectively locking the arm relative to the base.

There may also be provided a tidal energy capture system further comprising underwater turbines mounted to a turbine mount, the turbine mount being mounted to one of the float and base.

There may also be provided a tidal energy capture system wherein the underwater turbines are movable between a retracted position and a deployed position, wherein in the retracted position, the underwater turbines are withdrawn inside the turbine mount, and, in the deployed position, the underwater turbines protrude from the turbine mount.

There may also be provided a tidal energy capture system wherein the underwater turbines are pivotable so that a rotation axis of the underwater turbines is movable between a substantially horizontal orientation and a substantially vertical orientation.

There may also be provided a tidal energy capture system wherein the turbine mount is at a side surface of the one of the float and base.

There may also be provided a tidal energy capture system wherein the turbine mount is at a bottom surface of the one of the float and base.

There may also be provided a tidal energy capture system wherein the underwater turbines include blades, the blades being fenced.

There may also be provided a tidal energy capture system wherein the turbine mount extends downwardly from the one of the float and base.

There may also be provided a tidal energy capture system wherein the turbine mount is rotatable about a vertical turbine mount rotation axis relative to the one of the float and base.

In another broad aspect, there is provided a tidal power generation system for capturing tidal energy in a body of water experiencing tides, comprising: a base mounted to a ground; a float floating in the body of water adjacent the base; an arm extending between the base and the float and pivotable relative to the base; and a power generator operatively coupled to the arm for providing power when the arm pivots relative to the base.

There may also be provided a tidal energy capture system wherein the power generator is an electric generator usable to provide electricity, the tidal power generation system further comprising batteries for storing the electricity, a shipping dock for allowing a ship to dock to the tidal power generation system, and a transshipment crane usable to move the batteries between the tidal power generation system and the ship.

Advantageously, the proposed power generation system, is relatively simple, and therefore likely to be economical and relatively easy to manufacture. Also, in embodiments in which the float is submersible, the float can be submerged if severe weather occurs, which minimizes the stress on the mechanical structures of the power generation system. In embodiments in which the underwater turbines are provided, tidal energy can also be captures in more than one manner.

The present patent application claims priority from UK Request for a Patent GB2403219.5 filed Mar. 5, 2024, the contents of which is hereby incorporated by reference in its entirety.

Other objects, advantages and features of the present invention will become more apparent upon reading of the following non-restrictive description of some embodiments thereof, given by way of example only with reference to the accompanying drawings.

### BRIEF DESCRIPTION OF THE DRAWINGS

FIG. 1, in a perspective view, illustrates an embodiment of a tidal power generation system, according to the present invention, here shown comprising a stationary base rigidly anchored to the ground along a sea shore, and a float and arm arrangement extending from the stationary base, the float being shown in a first, or high tide, position;

FIG. 2, in a perspective view, illustrates the tidal power generation system shown in FIG. 1, here showing the float in a second, or low tide, position;

FIG. 3, in a perspective view, illustrates an other embodiment of a tidal power generation system, according to the present invention, here shown comprising a stationary base rigidly anchored to the sea floor and extending upwardly at least slightly above the sea surface at its highest sea tide level;

FIG. 4, in a side elevational view, illustrates yet another embodiment of a tidal power generation system, according to the present invention, here shown comprising a stationary base rigidly anchored in the sea floor and extending upwardly at an intermediary vertical position between the sea floor and the sea surface at its lowest tide level;

FIG. 5, in a side elevational view, illustrates the tidal power generation system shown in FIG. 4, here showing the float and arm arrangements submerged so as to avoid being damaged by a powerful sea hurricane raging along the sea surface;

FIG. 6, in a side elevational, cross-sectional view, illustrates an exemplary embodiment of a hydraulic cylinder in a close hydraulic circuit that is used as an actuable braking means for selectively maintaining a predetermined angle of a float and arm arrangement relative to a stationary base, as exemplified in FIGS. 4 and 5;

FIG. 7, in a side elevational view, illustrates a telescopic boom usable in the tidal power generation systems of FIGS. 1 to 5;

FIG. 8, in a perspective view, illustrates underwater turbines mounted to a turbine mount, the underwater turbines being shown in a retracted position;

FIG. 9, in a perspective view, illustrates the underwater turbines shown in FIG. 8 in a partially deployed position;

FIG. 10, in a perspective view, illustrates the underwater turbines shown in FIG. 8 in a deployed position;

FIG. 11, in a perspective view, illustrates the underwater turbines shown in FIG. 8 mounted to a pivotable turbine mount;

FIG. 12, in a perspective view, illustrates the underwater turbines shown in FIG. 8 mounted to a float;

FIG. 13, in a partial perspective view, illustrates the underwater turbines shown in FIG. 8 mounted to a base tethered to the sea floor;

FIG. 14, in a perspective view, illustrates the underwater turbines shown in FIG. 8 mounted to the base;

FIG. 15, in a side elevation view, illustrates the underwater turbines shown in FIG. 8 mounted to the base;

FIG. 16, in a side elevation view, illustrates an underwater turbine protected by a net or grid; and

FIG. 17, in a side elevation view, illustrates an array of underwater turbines protected by a net or grid.

### DETAILED DESCRIPTION

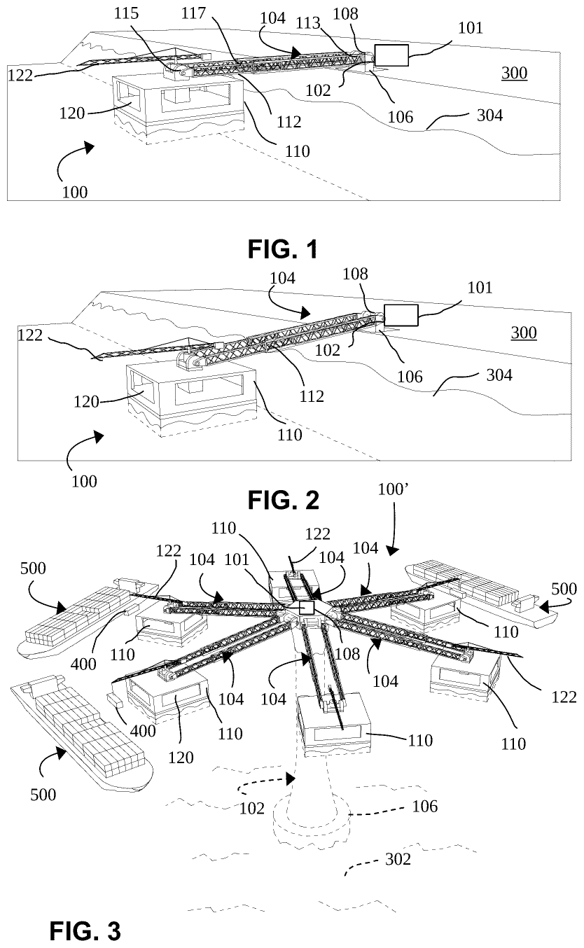

FIGS. 1 to 5 illustrate various embodiments, according to the present invention, of a tidal power generation systems 100, 100′ and 100″. In one embodiment of the tidal power generation system 100, 100′ and 100″, the latter comprises a stationary base 102, at least one float and arm arrangement 104, and at least one power generator 101.

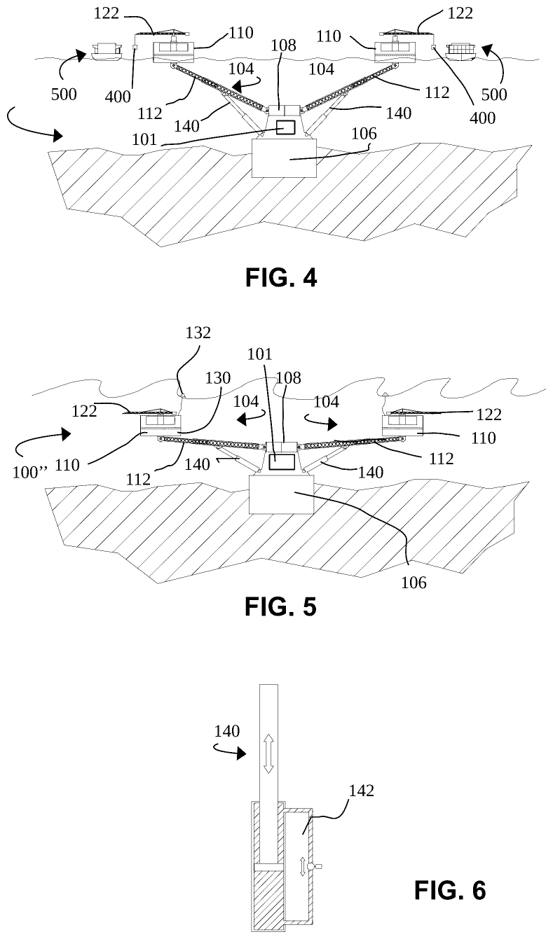

The stationary base 102 includes a stationary base lower end portion 106 mounted to a ground, for example by being stably anchored in an underlying ground surface, and a stationary base upper end portion 108 extending substantially upwardly relative to the stationary base lower end portion 106. For the tidal power generation system 100, the underlying ground surface is a dry land 300 location adjacent the sea shore 304, or in other words an above sea level coastal ground, as seen in FIGS. 1 and 2 for example. For the tidal power generation system 100′, the underlying ground surface is an off shore seabed 302, or in other words ground located under a body of water receiving the float of the float and arm arrangement 104, as seen in FIG. 3 for example. In this embodiment, the stationary base upper end portion 108 is located a location that is at least slightly above the highest sea tide level relative to the seabed 302. For the tidal power generation system 100″, the underlying ground surface is also an off shore seabed 302, but with the stationary base upper end portion 108 submerged and located at an intermediate location between the seabed 302 and the lowest sea tide level, as seen in FIGS. 4 and 5.

Each float and arm arrangement 104 includes a float, for example a floating barge 110, and an arm, for example taking the form of an elongated boom 112. However, other types of floats and arms are usable in alternative embodiments of the invention, as long as a floating object can transmit the up and down movements experienced due to tides to the power generator 101 through the arm. The floating barge 110 is suitably sized and shaped for substantially stably floating on a sea surface experiencing tidal sea level variations. The floating barge 110 floats on the sea adjacent the stationary base 102 and is connected to the latter through the boom 112.

As seen in FIG. 1 for example, the boom 112 has a substantially elongated configuration defined by a boom proximal end 113 pivotably connected to the stationary base 102, a boom distal end 115 pivotably connected to the floating barge 110, and an elongated boom intermediate portion 117 extending longitudinally between the boom proximal and distal ends 113 and 115. Each float and arm arrangement 104 is suitably sized and configured so as to extend substantially laterally away from a respective peripheral portion of the stationary base 102.

Furthermore, each float and arm arrangement 104 is pivotably movable relative to the stationary base 102 so as to be movable relative thereto between a first position and a second position, shown respectively in FIGS. 1 and 2. In the first position, the floating barge 110 is floating on the sea surface when the latter is at its highest tide level. In the second position, the floating barge 110 is floating on the sea surface when the latter is at its lowest tide level.

Each power generator 101 is suitably sized and configured for converting a pivoting movement of the boom 112 relative to the stationary base 102, into one of a usable electrical, mechanical or hydraulic power, among other possibilities. The power generator 101 therefore includes mechanisms and devices that convert the pivotal movement of the boom 112 to usable power. In a specific embodiment of the invention, the power generator 101 is an electric power generator.

The power generators 101 may for example be coupled between the stationary base upper end portion 108 and a respective one of the boom proximal end 113 pivotably connected thereto, between each boom distal end 115 and its respective floating barge 110, or between the stationary base upper end portion 108 and simultaneously with the boom proximal end of all the float and arm arrangements 104.

With stationary base lower end portion 106 anchored in the seabed 302 and the stationary base upper end portion 108 extending at least slightly above the highest sea tide level, as in the tidal power generation system 100′, each boom distal end 115 is pivotably mounted to a top or side portion of the respective floating barge 110. Furthermore, with stationary base lower end portion 106 anchored in the seabed 302 and the stationary base upper end portion 108 located at least slightly below the lowest sea tide level, as in the tidal power generation system 100″, each of the boom distal ends 115 is pivotably mounted to a side or bottom portion of the respective floating barge 110.

The power generators 101 may include transmissions or other power conversion devices that can take the relatively high torque and low speed movements of the booms 112 and convert these movements to usable power in conventional manners. Such power conversion devices are well-known in the art of tidal power generation and therefore not described in details herein.

In some embodiments, the tidal power generation system 100 may be advantageously used as a land electrical power station for a nearby village or sea port or as a stand alone off shore charging station for large and small boats and sea ships equipped with hybrid or fully electrically powered engines.

In some off shore embodiments of the invention, the stationary base 102 is a buoyant stationary base 102 that is rigidly and stably anchored in the seabed 302 using a suitable arrangement of anchor cables. A buoyant stationary base 102 thus anchored to the seabed may be used in the off shore embodiment of the present invention having a partially submerged stationary base 102, as illustrated in FIG. 3, as well as the embodiment including a fully submerged stationary base 102, as illustrated in FIGS. 4 and 5. Off shore buoyant stationary bases with anchor cable arrangements are well known in the art of, for example, off shore wind turbines, off shore oil well platform, and the likes.

In some off shore embodiments of the invention, as exemplified in FIGS. 3 to 5, the floating barge 110 is suitably configured, sized and equipped to serve as a floating charging station for large and small fishing boats, cargo ships and tourists cruise vessels equipped with hybrid or fully electrically powered engines.

For example, as exemplified in the figures, the floating barge 110 may be suitably sized and configured to include one or more shipping docks 120, multiple battery storage space in its hold, and a transshipment crane 122 usable for transshipment of depleted shipping container size batteries 400 that are replaced with freshly charged ones on cargo ships 500 as illustrated. Thus, in a similar manner as truck stops distributed along highways, the off shore embodiments of the tidal power generation system 100 of the present invention may be advantageously installed at regular intervals along relatively long shipping routes.

In other embodiments, the transshipment crane 122, or any equivalent actuable structure, may be also used to extend one or more charging cables to a ship located in proximity with the floating barge 110. Furthermore, other known types and configurations of means for transshipment of batteries 400 between the floating barge 110 and the ships can be used.

In some off shore embodiments of the invention, as exemplified in FIGS. 3 to 5, the tidal power generation system 100′ or 100″ comprises a plurality of float and arm arrangements 104 that extend radially from the stationary base 102 and that are circumferentially equidistant from each other, so as to impart greater lateral stability to the tidal power generation system 100′ or 100″ during the cyclic vertical tidal movements of the sea. Thus advantageously, as best illustrated in FIG. 3, the radial distribution of the plurality of float and arm arrangements 104 allows simultaneous access to relatively large cargo ships 500 having hybrid or fully electrically powered engines to recharge or exchange depleted batteries 400 with freshly recharged ones.

In some off shore embodiments of the invention, as exemplified in FIGS. 4 and 5, the floating barge 110 further includes a suitably configured and sized ballast system 130 for selectively adjusting a buoyancy of the floating barge 110, so that the floating barge 110 me be selectively temporarily sunk below the sea surface before a forecasted hurricane, and then refloated when the environmental conditions are appropriate. Thus, the most vulnerable portions of the tidal power generating system 100″ may be spared from potentially damaging weather conditions.

In some embodiments, the ballast system 130 is provided with a selectively retractable floating snorkel tube 132 for allowing access to surface air during refloating operations of the floating barge 110, when the ballast system 130 is emptied of water, rather than using a system with compressed air tanks, which consumes significantly more energy to operate.

Alternatively, in some embodiments of the invention (not shown in the figures), surface air is provided to each floating barge 110 equipped with a ballast system 130 through a suitable centralized air conduit network extending to the surface via the partially submerged stationary base 102, as illustrated in FIG. 3, or a centralized retractable snorkel via the fully submerged stationary base 102.

Furthermore, in some embodiments of the invention, each one of the float and arm arrangement 104 further includes a hydraulic cylinder arrangement 140 operatively coupled between the stationary base 102 and the elongated boom 112. The hydraulic cylinder arrangement 140 is one of a known closed circuit type via an actuable valve 142, as exemplified in FIG. 6, or a hydraulically powered type via a suitable hydraulic pump system (not shown in the figures). The hydraulic cylinder arrangement 140 may be used to stabilize the respective floating barge 110 during active charging or transshipment operations with one or more ships by locking the boom 112 relative to the base 102. This operation can be effected by stopping the flow of hydraulic fluid within the hydraulic cylinder arrangement 140.

It is also contemplated that the hydraulic cylinder arrangement 140 may be used as a selectively actuable brake system to maintain the respective floating barge 110 temporarily above its floating line once the surrounding sea surface has reached its highest sea tide level. Hence, the braking effect of hydraulic cylinder arrangement 140 may then be released so as to benefit from a greater gravity force pushing down on the elongated boom 112 and, thus, significantly increase the mechanical power available for conversion into usable electrical power.

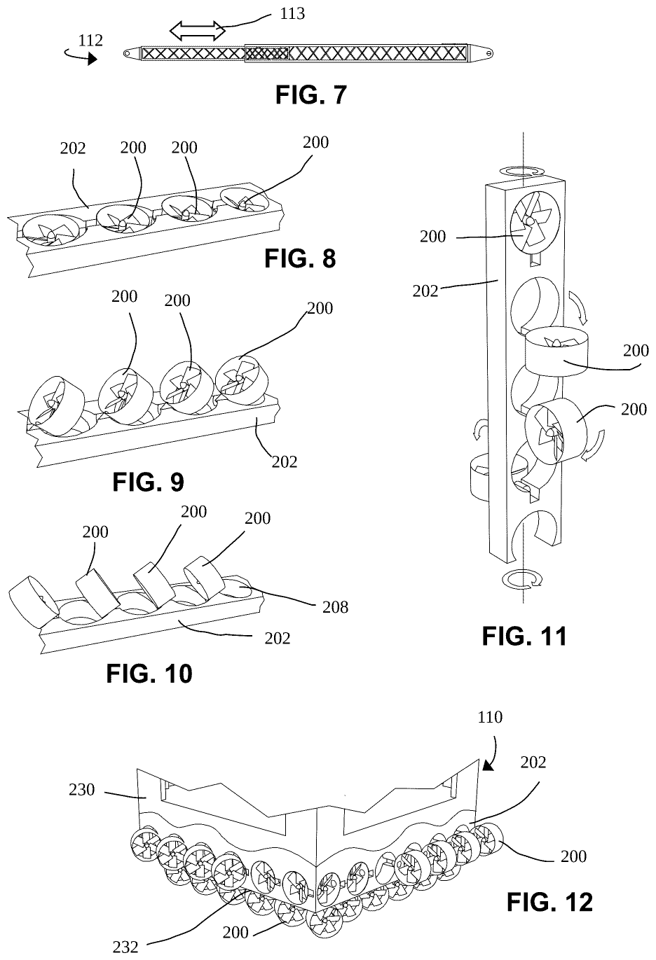

In some embodiments of the invention, as seen in FIG. 7, the boom 112 is telescopic, as indicated by arrow 119, and movable between a boom retracted position and a boom extended position, wherein the elongated boom 112 has a shorter length dimension in the boom retracted position then in the boom extended position.

The elongated boom 112 may be telescopically movable using any suitable telescopic actuator, such as an electrically or hydraulically powered actuator, for large applications of the tidal power generation system 100, 100′ and 100″. Alternatively, the elongated boom 112 may be user selectively and telescopically adjusted by hands in relatively small applications of the tidal power generation system 100, 100′ and 100″.

Advantageously, the tidal power generation system 100, 100′ and 100″ thus provided with a telescopically movable elongated boom 112 may be relatively easily and economically adapted to various situations and environmental constraints using one and same construction or assembly configuration of the invention. For example, the elongated boom 112 may be telescopically adjusted so as to allow the stationary base 102 to be anchored on an economically advantageous location on dry land that is more or less near the sea shore, so as to have the booms 112 extend through a crevice between two elevated rock formations in proximity to the sea shore. Another advantage of the telescopically movable booms 112 resides in that the latter may be relatively easily length adjusted so as to be adapted to the specific transmission ratio of a new generator 101 installed in the tidal power generation system 100, in replacement of a defective one.

Another advantage of the telescopically movable boom 112 resides in that, when a significant hurricane is forecasted in the region, the telescopically movable boom 112 may be extended so as to allow the floating barge 110 to be temporarily sunk below the sea surface further away from the sea shore where the seabed is relatively deeper and the surface waves less violent. Thus, the most vulnerable portions of the invention may be spared from potentially damaging weather conditions.

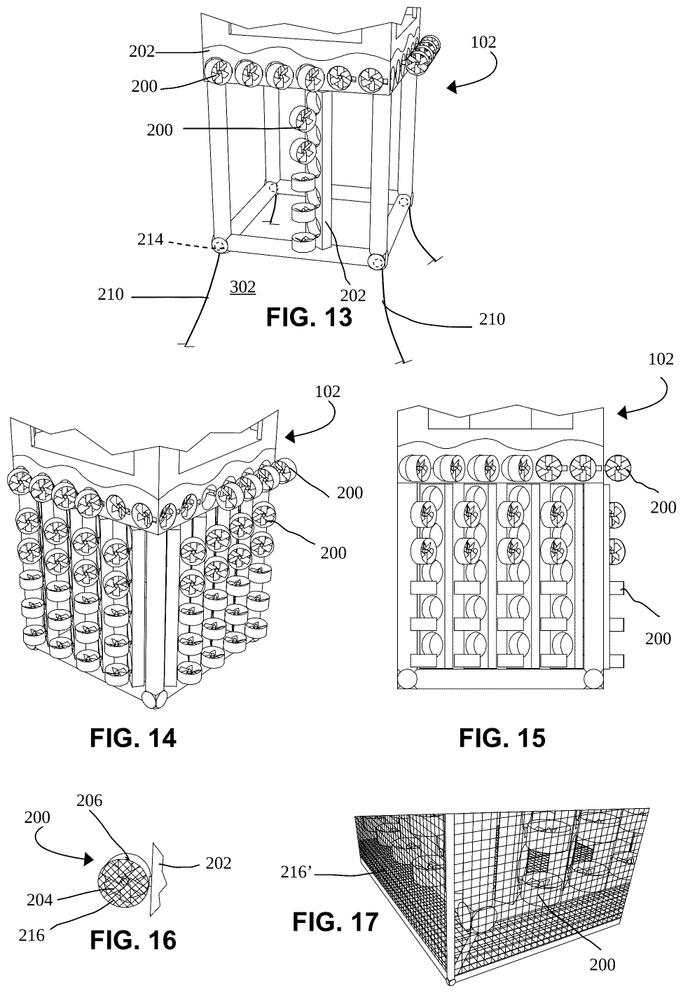

Referring collectively to FIGS. 8 to 17, in some embodiments, the tidal power generation system 100, 100′ and 100″ may further comprise underwater turbines 200 mounted to a turbine mount 202. The turbine mount 202 is mounted to the floating barge 110, as illustrated in FIG. 12, to the base 102 if the latter is at sea, or to both the base 102 and floating barge 110.

The underwater turbines 200 include blades 204 that can rotate when water flows through the blades 204, for example due to tidal water movements or to any other water movement. The underwater turbines 200 include a conventional generator able to convert the rotational movement of the blades 204 to electricity using magnet and coil combinations. In some embodiments, as shown in the drawings, the blades 204 are surrounded by a shroud 206.

The underwater turbines 200 are movable relative to the turbine mount 202 between a retracted position, shown in FIG. 8 for example, and a deployed position, shown in FIG. 10 for example. FIG. 9 illustrates a partially deployed position of the underwater turbines 200. In the retracted position, the underwater turbines 200 are withdrawn inside the turbine mount 202, so that the blades 204 don't protrude therefrom. In the deployed position, the underwater turbines 200 protrude from the turbine mount 202, so that any movement of water adjacent the turbine mount 202 can rotate the blades 204.

In a specific embodiment of the invention, the turbine mount 202 defines recesses 208 each for receiving one of the underwater turbine 200 thereinto in the retracted position. The underwater turbines 202 are pivotally mounted to the turbine mount 202 so as to be movable between the retracted and deployed positions, for example through as motorized axle mounted to the turbine mount 202 (not shown in the drawings). In some embodiments, the range of motion between the retracted and deployed positions exceeds 90 degrees, for example about 135 degrees, which allows adjustment of the orientation of the underwater turbines 200 to maximize energy capture.

The turbine mounts 202 may be at a side surface 230 of the floating barge 110 or base 102, at an underside surface 232 of the floating barge 110 or base 102, or at an intersection between a side surface 230 and an underside surface 232 of the floating barge 110 or base 102, as seen in FIG. 12 for the floating barge 110. For example, the turbine mounts 202 are integrally formed in the floating barges 110, so that in the retracted position, the underwater turbines 202 don't protrude from the floating barge 110. The retracted position in such embodiments allows one to stow the underwater turbines 200 when needed, for example for maintenance of the floating barge 110, when one wants to approach the floating barge 110 with a ship, or for any other reason.

In other embodiments, some or all the turbine mounts 202 protrude downwardly from floating barges 110 or from the base 102, as seen in FIGS. 14 and 15. It should be noted that in some embodiments provided with the underwater turbines 200, the floating barges 110 and the float and arm arrangements 104 may be omitted, as tidal power is only captured by the underwater turbines 200. In such embodiments, the base 102 may be anchored to the sea floor 302 through anchoring cables 210. These anchoring cables 212 can be lengthened or shortened using a corresponding winch 214 mounted to the base 102. In such embodiments, the anchoring cables 212 are not necessarily under a large tension, and may be used to maintain the base 102 around a suitable location, while allowing small horizontal drifts.

In such embodiments, as seen in FIG. 11 for example, the underwater turbines 200 may be pivotable so that a rotation axis 201 of the underwater turbines is movable between a substantially horizontal orientation and a substantially vertical orientation. This rotation allows one to maximize energy capture according to the direction of water flow during the tides. For example, shallower underwater turbines may have their rotation axis 201 horizontal, while deeper underwater turbines may have their rotation axis 201 vertical. To further maximize energy capture, the turbine mount 202 may also be rotatable about a vertical turbine mount rotation axis 205 relative to the base 102.

In some embodiments, the blades 204 are fenced. For example, a net or solid grid 216 or 216′ is provided across the shroud 206, as seen in FIG. 16, or surrounding the entirety of the turbine mounts 202, as seen in FIG. 17.

To further energy production, the tidal power generation systems 100, 100′ and 100″ may be provided with solar panels, wind turbines or small nuclear power generators, among other possibilities.

Although the present invention has been described hereinabove by way of exemplary embodiments thereof, it will be readily appreciated that many modifications are possible in the exemplary embodiments without materially departing from the novel teachings and advantages of this invention. Accordingly, the scope of the claims should not be limited by the exemplary embodiments, but should be given the broadest interpretation consistent with the description as a whole. The present invention can thus be modified without departing from the spirit and nature of the subject invention as defined in the appended claims.

What is claimed is:

1. A tidal energy capture system for powering a power generator by capturing tidal energy in a body of water experiencing tides, comprising:
a base mounted to a ground;
a float floating in the body of water adjacent the base; and
an arm extending between the base and the float and pivotable relative to the base, the arm being connectable to the power generator for powering the power generator when the float is moved up and down relative to the base by tides.

2. The tidal energy capture system as defined in claim 1, wherein the ground is above sea level coastal ground.

3. The tidal energy capture system as defined in claim 1, wherein the ground is submerged ground located under the body of water.

4. The tidal energy capture system as defined in claim 3, wherein the base is supported on the ground.

5. The tidal energy capture system as defined in claim 3, wherein the base is buoyant and anchored to the ground.

6. The tidal energy capture system as defined in claim 1, wherein the arm is telescopic.

7. The tidal energy capture system as defined in claim 1, wherein the float is provided with a ballast system for selectively adjusting a buoyancy of the float.

8. The tidal energy capture system as defined in claim 7, wherein the float is selectively submersible.

9. The tidal energy capture system as defined in claim 7, wherein the ballast system includes a snorkel for accessing the atmosphere to pump air in the ballast system when emptying the ballast system.

10. The tidal energy capture system as defined in claim 1, further comprising a hydraulic cylinder extending between the base and the arm and operative for selectively locking the arm relative to the base.

11. The tidal energy capture system as defined in claim 1, further comprising underwater turbines mounted to a turbine mount, the turbine mount being mounted to one of the float and base.

12. The tidal energy capture system as defined in claim 11, wherein the underwater turbines are movable between a retracted position and a deployed position, wherein in the retracted position, the underwater turbines are withdrawn inside the turbine mount, and, in the deployed position, the underwater turbines protrude from the turbine mount.

13. The tidal energy capture system as defined in claim 11, wherein the underwater turbines are pivotable so that a rotation axis of the underwater turbines is movable between a substantially horizontal orientation and a substantially vertical orientation.

14. The tidal energy capture system as defined in claim 12, wherein the turbine mount is at a side surface of the one of the float and base.

15. The tidal energy capture system as defined in claim 12, wherein the turbine mount is at a bottom surface of the one of the float and base.

16. The tidal energy capture system as defined in claim 11, wherein the underwater turbines include blades, the blades being fenced.

17. The tidal energy capture system as defined in claim 11, wherein the turbine mount extends downwardly from the one of the float and base.

18. The tidal energy capture system as defined in claim 17, wherein the turbine mount is rotatable about a vertical turbine mount rotation axis relative to the one of the float and base.

19. A tidal power generation system for capturing tidal energy in a body of water experiencing tides, comprising:
a base mounted to a ground;
a float floating in the body of water adjacent the base;
an arm extending between the base and the float and pivotable relative to the base; and
a power generator operatively coupled to the arm for providing power when the arm pivots relative to the base.

20. The tidal power generation system as defined in claim 19, wherein the power generator is an electric generator usable to provide electricity, the tidal power generation system further comprising batteries for storing the electricity, a shipping dock for allowing a ship to dock to the tidal power generation system, and a transshipment crane usable to move the batteries between the tidal power generation system and the ship.
